(19) United States
(12) Patent Application Publication
(10) Pub. No.: US 2011/0146472 A1
(43) Pub. Date: Jun. 23, 2011

(54) METHOD AND SYSTEM TO ADJUST THE SAME GUITAR TO A LEFT OR A RIGHT HANDED GUITAR PLAYER

(76) Inventors: Guy Chetrit, Modi'in (IL); Maor-Liel Nachum, Lapid (IL)

(21) Appl. No.: 12/646,316

(22) Filed: Dec. 23, 2009

(51) Int. Cl. G10D 3/04

(52) U.S. Cl. 84/298

(57) ABSTRACT

A guitar with a sliding base, enabling to play in the same guitar, either, with left hand, or with right hand. Wherein, the first end of the connecting section of the guitar strings, located at the guitar wide area, connected to the present invention system, that includes part that connected to the guitar body, and has a track that another part is connected to, wherein, one side of the upper part, is detachable and enabling to slide the upper part from one side of the track to another side of the track, causing reversal and turning the upper part upper side to face the guitar body, and the part that was face to the guitar body staring up. Whereby, the guitar strings are connected to that system, while turning the system of the present invention up side down, the guitar strings are changing direction on the guitar body. Wherein, respectively, both end of the system at the guitar are to be turn side in order to enabling turning guitar from right handed guitar to a left handed guitar and the same in the opposite changing direction.

### FIELD of the INVENTION

This invention is in the field of music instruments and in particular a guitar with means of converting a right-handed guitar to a left-handed guitar in a manner which is entirely reversible

### BACKGROUND OF THE INVENTION

Guitar as most of the stringed musical instruments is one of the musical instruments that discriminate left-handed. In the preferred embodiment the dominant hand would be the one to strum on the strings and the second hand would deal with the fretting that required lesser mechanical task. Most guitars are built for right-handed player, with the bas string in the top and the melody strings in the bottom, Left-handed guitars are uncommon and available in less variety than right-handed ones and in consequence left-handed players are disadvantaged in choice and variety of instruments available to them. Moreover, if a left-handed player were to play the same guitar design for right-handed and would want to strum with his dominant left hand he would need to turn the guitar upside down and to reverse the order of the string, therefore many left-handed players learn to play guitars strung in the manner used by right-handed people and learn to strum with their non dominant hand.

What is needed therefore is a system and method or means for converting a right-handed guitar to a left-handed guitar in a reversible manner.

### SUMMARY OF THE INVENTION

It is to be understood that both the foregoing general description and the following detailed description present embodiments of the invention and are intended to provide an overview or framework for understanding the nature and character of the invention as it is claimed.

This invention reveals a system and method of converting conventional right-handed guitars to be playable by a left-handed player by reversal fast and easy manner. A guitar enabling to turned over the convert a right-handed guitar to a left-handed guitar in a fast easy and reversible manner.

The guitar would have a bridge located at the guitar wide area, which enabling tuning adjustment of each one of the strings independently from the other strings, wherein, the bridge can be turned around enabling to play on that guitar by both right handed and left handed people.

The bridge would be place on the guitar on a base and would be connected permanently from one side of it by a pivot point, that would function as an hinge that can be moved from one side of the base track to the other side of the base track, able to detach from the guitar from one side and to be turned over to the other side, and the other side of the bridge, will be free at the time of shifting side, and will be secured to the base when the changing and shifting sides is completed, and before the user act of playing the guitar.

When turning over the side of the bridge the order of the string would changed in a way that if for example on side A the bas string was the first from the top, as in a regular guitar when playing by right hand, then when the bridge is turned over to side B the bas string would be the first from the bottom so when turning the guitar to be played by the left hand then the bas will be the first from the top as in a guitar designed special for left handed people and not for right handed people.

It is well known to the one skilled in the art, that the distant end of the strings, located at the end of the guitar narrow neck, will have reversible mechanism, similar to the one described, that will be turned over respectively to the string turning direction, to enable the operation and goal of the present invention.

### BRIEF DESCRIPTION OF THE DRAWINGS

The accompanying drawings are included to provide a further understanding of the invention and are incorporated into and constitute a part of this specification. The drawings illustrate various embodiments of the invention and, together with the description, serve to explain the principles and operations of the invention, by way of example only and not to limit the invention to these descriptions only.

FIG. 1 is a schematic diagram of the guitar with the system of the present invention connected to the guitar.

FIG. 2 is a schematic diagram of the Strings Bridge with the system of the present invention connected to the base as part of the guitar.

FIG. 3 is a schematic diagram of the Strings Bridge with the system of the present invention connected to the base from one side in time of changing direction as in the present invention.

FIG. 4 is a schematic diagram illustrates a plan view of the Strings Bridge with the system of the present invention connected to the base as part of the guitar.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.
1. FIG. 1 is a schematic a view of a guitar with the system of the present invention 100 connected to the guitar. the first end of the connecting section of the guitar strings, located at the guitar wide area 102, connected to the present invention system, that includes base part 114 that connected to the guitar body, and has a track that another part 110 is connected to, wherein, one side of the upper part 116, is detachable and enabling to slide the upper part from one side of the track 114 to another side of the track, causing reversal and turning the upper part upper side to face the guitar body, and the part that was face to the guitar body staring up. Whereby, the guitar strings are connected to that system, while turning the system of the present invention up side down, the guitar strings are changing direction on the guitar body. Wherein, respectively, both end of the system at the guitar, even the far part of the system 108 that is on the narrow end of the guitar 104 is to be turn side by the same turning sides system connected to base 120, in order to enabling turning guitar from right handed guitar to a left handed guitar and the same in the opposite changing direction. Wherein, the distant end of the strings, pass through the guitar neck 106 located at the end of the guitar narrow neck, will have reversible mechanism 108 and 120, similar to the one described at the guitar body 102, that will be turned over respectively to the string turning direction, to enable the operation and goal of the present invention. Tuning adjustment part 112 enabling adjustment of each one of the strings, and is to be part of the system of the present invention. Whereby, the system according to the present invention includes a common connecting means, such as straps, that enabling to secured or connect the system to regular guitar and change it to a right and left hand guitar such as in the present invention.
FIG. 2 is a schematic diagram 150 of the Strings Bridge with the system of the present invention connected to the base 152 as part that has a track that another part of the system is connected to, wherein, one side of the upper part 160, is detachable and enabling to slide the upper part from one side of the track 152 to another side of the track 162, causing reversal and turning the upper part upper side to face the guitar body, and the part that was face to the guitar body staring up. Whereby, the guitar strings 154 are connected to the upper part 160 by channels 158 and adjustable buttons 156.

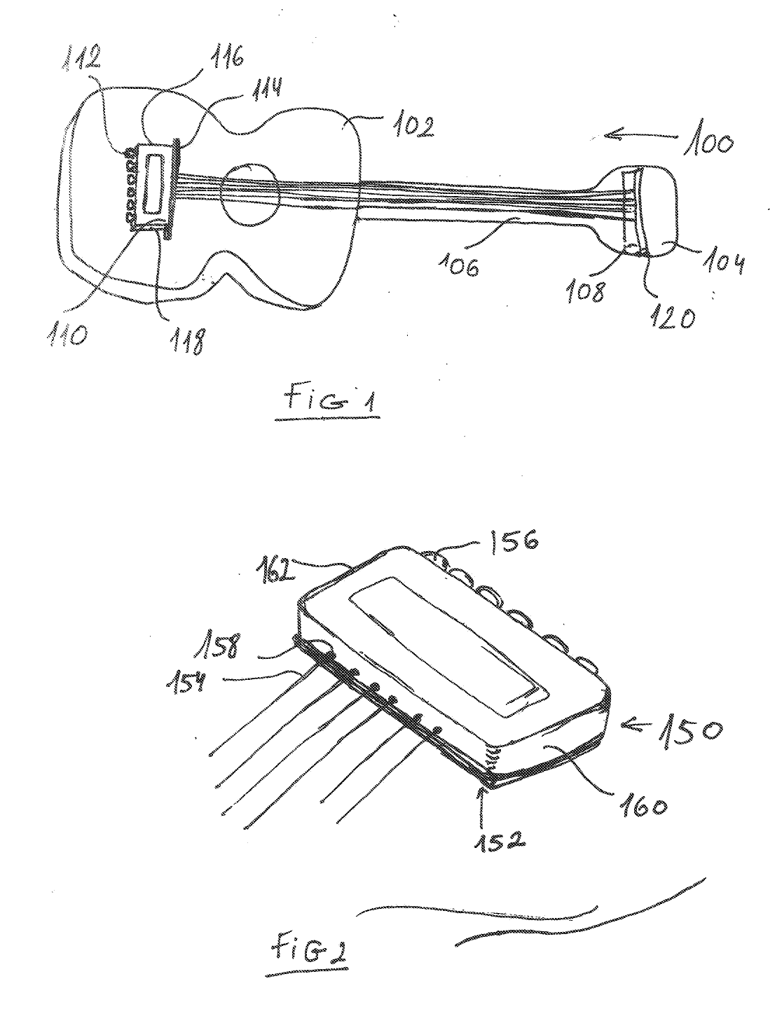

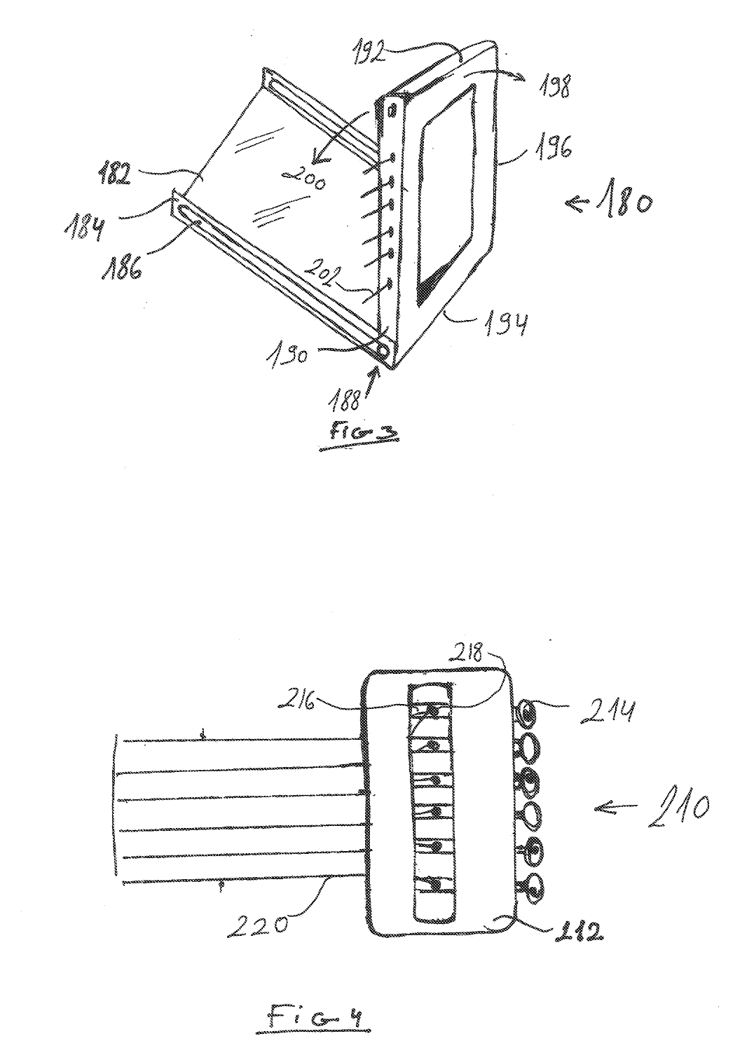

FIG. 3 is a view of the Strings Bridge with the system of the present invention 180 connected to the base 182 from one side 190 in time of changing direction as in the present invention. The bridge 196 would be place on the guitar on a base and would be connected permanently from one side of it by a pivot point 188, that would function as an hinge that can be moved from one side 188 of the base track 182 to the other side 184 of the base track 186, able to be detach from the guitar from one side 198 and to be turned over to the other side 200, and the other side of the bridge 192, will be free at the time of shifting side, and will be secured to the base 182 when the changing and shifting sides is completed, and before the user act of playing the guitar strings 202.
FIG. 4 is a schematic diagram 210 of the Strings Bridge 212 with the system of the present invention, wherein, the guitar strings 220 are connected to the system by channels 216 and connecting means 218 that enabling the connecting of each string to its place as required in guitars, and adjustable buttons 214 controlling the adjustments of each string.

What is claimed:

1. A guitar with system including a sliding Strings Bridge on a base, enabling to play in the same guitar, either, with left hand, or with right hand,
Wherein, the first end of the connecting section of the guitar strings, located at the guitar wide area, connected to system, that includes base part that connected to the guitar body, that has a track that another part, the Strings Bridge, is connected to,
Wherein, one side of the upper part of the Strings Bridge, is detachable and enabling to slide the upper part from one side of the base track to another side of the base track, causing reversal and turning the upper part of the Strings Bridge upper side to face the guitar body, and the part that was face to the guitar body staring up,
Wherein, the guitar strings are connected to that system, while turning the system of the present invention up side down, the guitar strings are changing direction on the guitar body,
Wherein, respectively, both end of the system at the guitar are to be turn side in order to enabling turning guitar from right handed guitar to a left handed guitar and the same in the opposite changing direction,
Wherein, the distant end of the strings, located at the end of the guitar narrow neck, will have reversible mechanism, similar to the one described, that will be turned over respectively to the string turning direction, to enable the operation and goal of the present invention.

2. The system according to claims 1, wherein the system includes adjusting tuning mechanism to the strings connected to the system parts and having an adjusting buttons.

3. The system according to claims 1, wherein the system is a detachable part that can be connected or replaced to another system.

4. The system according to claims 1, wherein the system include a connecting means that enabling to connect the system to regular guitar and change it to a right and left hand guitar.

5. A method and system including a sliding Strings Bridge on a base, enabling to play in the same guitar, either, with left hand, or with right hand,
Wherein, the first end of the connecting section of the guitar strings, located at the guitar wide area, connected to system, that includes base part that connected to the guitar body, that has a track that another part, the Strings Bridge, is connected to,
Wherein, one side of the upper part of the Strings Bridge, is detachable and enabling to slide the upper part from one side of the base track to another side of the base track, causing reversal and turning the upper part of the Strings Bridge upper side to face the guitar body, and the part that was face to the guitar body staring up,
Wherein, the guitar strings are connected to that system, while turning the system of the present invention up side down, the guitar strings are changing direction on the guitar body,
Wherein, respectively, both end of the system at the guitar are to be turn side in order to enabling turning guitar from right handed guitar to a left handed guitar and the same in the opposite changing direction,
Wherein, the distant end of the strings, located at the end of the guitar narrow neck, will have reversible mechanism, similar to the one described, that will be turned over respectively to the string turning direction, to enable the operation and goal of the present invention.
